(19) United States
(12) Patent Application Publication
(10) Pub. No.: US 2010/0213313 A1
(43) Pub. Date: Aug. 26, 2010

(54) INTEGRATED AIRCRAFT CARGO LOADING AND CARGO VIDEO MONITORING SYSTEM

(75) Inventors: Blake Allen Reed, Jamestown, ND (US); Louis Carl Samuelson, Jamestown, ND (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: Goodrich Corporation, Charlotte, NC (US)

(21) Appl. No.: 11/934,202

(22) Filed: Nov. 2, 2007

Related U.S. Application Data
(60) Provisional application No. 60/864,476, filed on Nov. 6, 2006.

(51) Int. Cl. B64D 9/00

(52) U.S. Cl. 244/118.1

(57) ABSTRACT

An integrated cargo loading and video monitoring system for an aircraft having at least one cargo compartment is disclosed. The system includes a cargo loading processor and a plurality of power drive units within the cargo compartment, each power drive unit being coupled to the cargo loading processor. The system also includes a video processor, and at least one video camera within the cargo compartment, the camera being coupled to the video processor. A central processor in communication with the cargo loading processor and the video processor is operable to receive information from both the cargo loading processor and from the video processor.

### FIELD OF THE INVENTION

The invention relates to systems for aircraft, and more particularly relates to an integrated system for monitoring and managing aircraft cargo loading activity, and for visually monitoring an aircraft's cargo compartments.

### BACKGROUND

With the increasing emphasis on expedited “overnight” shipments, the number and volume of air cargo shipments is increasing. Some aircraft used for air cargo shipments are configured to transport only cargo, while other aircraft are configured to transport both passengers and cargo.

Typically, items being shipped by air are first loaded onto specially configured pallets or into specially configured containers. In the airfreight industry, these various pallets and containers are commonly referred to as Unit Load Devices (“ULDs”). ULDs are available in various sizes, shapes and capacities, and typically bear external markings that identify their type, maximum gross weight, tare weight, and other pertinent information.

A ULD typically is loaded with cargo at a location that is distant from the immediate vicinity of an aircraft. Once a ULD is loaded with cargo items, the ULD is weighed, transferred to the aircraft, and is loaded onto an aircraft through a doorway or hatch using a conveyor ramp, scissor lift, or the like. Once inside the aircraft, a ULD is moved about the cargo compartment until it reaches a final stowage position. Multiple ULDs are brought onboard the aircraft, and each is placed in its respective stowed position.

Various types of aircraft that are used to exclusively transport cargo have variously arranged cargo compartments for receiving and stowing ULDs. As shown in FIGS. 1 and 2, a typical large cargo aircraft 10 includes a forward cargo compartment 12a and an aft cargo compartment 12b located beneath the aircraft's main deck 16, and within the aircraft's “lower lobe.” These cargo compartments commonly are referred to as the “forward lower lobe” 12a and the “aft lower lobe” 12b, respectively. In addition to forward and aft lower lobes 12a, 12b, a typical large cargo aircraft 10 often is equipped to receive and stow ULDs 18 on its main deck 16 in a main deck cargo compartment 14. A cargo aircraft 10 may be loaded with ULDs of various types, shapes, and sizes. As shown in FIG. 2, spaces or gaps typically exist between and around at least some adjacent ULDs 18 in their stowed positions.

To facilitate movement of a ULD within an aircraft cargo compartment as the ULD is loaded, stowed, and unloaded, the deck of an aircraft cargo compartment typically includes a number of raised roller elements. These roller elements often include elongated roller trays that extend longitudinally along the length of the cargo deck, ball panel units, and the like. For example, roller trays typically include elongated rows of cylindrical rollers that extend in a fore and aft direction. Ball panel units include plates with upwardly protruding spherical balls. The ULDs sit atop these roller elements, and the roller elements facilitate rolling movement of the ULDs within the cargo compartment. Cargo decks also commonly are equipped with one or more power drive units (PDUs). PDUs are electrically powered rollers that can be selectively raised above the roller elements, and selectively energized to propel a ULD across a cargo deck in a desired direction. One example of a PDU is described in U.S. Pat. No. 6,834,758 to Goodrich Corporation. Some PDUs may be equipped with one or more sensors for detecting the presence or absence of a ULD directly above the PDU. An example of one such ULD-sensing PDU is described in co-pending U.S. patent application Ser. No. 11/469,643 filed Sep. 1, 2006, and assigned to Goodrich Corporation.

Typically, a person responsible for loading or unloading ULDs selectively controls operation of an aircraft's PDUs from a master cargo control panel 20, like that shown in FIG. 3. Typically, such a master cargo control panel 20 typically is located at a convenient location near the doorway of an aircraft's main deck and/or lower cargo deck. An aircraft may also be equipped with one or more local cargo control panels 30 like that shown in FIG. 4. The control panels 20, 30 are configured to permit a person to selectively raise and engage one or more PDUs with a pre-positioned ULD, and to selectively activate the PDU to propel the ULD in a forward or aft direction within a cargo compartment.

Once a ULD is moved to its final stowed position, the ULD must be restrained against both vertical and lateral movement during flight. Accordingly, the deck and sidewalls of a cargo compartment typically include a plurality of restraint devices that selectively engage the stowed ULD, and keep the ULD stationary. One example of such a restraint is a latch that is removably fixed to the floor, and is selectively movable between a deployed (latched) position and a retracted (unlatched) position. In the deployed position, an engaging member of the latch is upright, and protrudes above the upper surface of the roller elements. In the retracted position, the engaging member is recessed below the upper surface of the roller elements such that the engaging member will not interfere with movement of a ULD passing overhead. The engaging member can be manually moved between its deployed and retracted. Such restraint latches are known in the art, and are commercially available in various types and sizes. The restraint latches are positioned at predetermined “install points” on a cargo deck. Such install points coincide with deck locations having features for receiving and retaining a restraint latch, such as recesses, holes, slots, pins, cutouts, or the like. One example of an install point is a recess between upwardly extending rails of a roller track recessed within a cargo deck. Installation points also commonly are provided along side rails on sidewalls of the cargo compartments.

A typical aircraft cargo deck may include several hundred install points. However, for a given cargo configuration, not all install points are populated with restraints due to weight and cost considerations. For example, on a cargo deck having about eight hundred total install points, only about three hundred of the install points may require restraints. Usually, an aircraft operator will consider the types and sizes of ULDs that are likely to be required for a particular load configuration, and will install the appropriate number of restraints before cargo loading according to such projections.

Each ULD normally requires multiple restraint devices, and different types of ULDs require different numbers of restraints. Operational criteria for each ULD specify the required number, type and locations of restraints based on a ULDs maximum gross weight. Such operational criteria also specify a reduced maximum gross weight for situations where one or more of the required restraints are missing or otherwise unavailable. Thus, on a given flight, if one of several restraints to be used to secure a ULD is damaged or missing, that ULD may still be transported in the chosen position, but only if it meets the reduced maximum gross weight specification.

The number of ULDs, the types of ULDs to be transported, and the weight of each ULD often vary between flights. Care must be taken when loading aircraft with cargo to ensure that the final weight and balance of the aircraft is acceptable. An aircraft's performance and handling characteristics are affected by the aircraft's gross weight and its effective center of gravity. An overloaded or improperly balanced aircraft will require more power and greater fuel consumption during flight, and the aircraft's stability and controllability may be affected.

Before ULDs are loaded onto an aircraft, a person in charge of the loading activities (hereinafter the “load master”) develops a desired load configuration that contemplates the aircraft's weight and balance criteria, and the number, types and weights of the ULDs to be loaded. The load configuration defines where each of the ULDs should be located on a cargo deck. In its simplest form, a load configuration can be a two-column list that includes a first column identifying each ULD, and a second column identifying a desired stowed position for each ULD.

Typically, a loading crew tasked with loading an aircraft receives a printed copy of the loadmaster's load configuration. In order to ensure that each ULDs operational restraint requirements are satisfied, ground crew members ensure that restraints of the correct type are installed at the various install points required by the load configuration. Often, a loading crewmember tasked with configuring restraints according to a given loading configuration must rely on his familiarity with various ULDs, restraints, and cargo deck equipment. The loading crewmember also may be assisted by color-coded markings on the cargo deck that designate install points and the like. The loading crewmember performs a visual inspection, and determines whether operable restraints of the correct types are installed at the correct install points for each ULD to be loaded onto the aircraft.

During inspection, a loading crewmember may discover a missing, damaged, or inoperable restraint. In such a case, the crewmember typically reports such findings to the loadmaster, who then may check the ULD operational criteria to determine whether a ULD with a lighter weight or of a different type might be relocated to an affected ULD location. Sometimes, a restraint may be moved from one install point to another install point having a missing or damaged restraint, such that restraint requirements for all ULDs ultimately are satisfied.

In order to assist air cargo loading crews, automated cargo loading systems have been developed. One such automated cargo loading system is described in published U.S. Patent Application No. 2006/0038077 A1, assigned to Goodrich Corporation. The described system is configured to automatically identify, track, and report the positions of ULDs within an aircraft in real time, thereby permitting a person who is remote from loaded ULDs to monitor the current status of loading or unloading activities. In such a system, each ULD may include a machine-readable wireless tag that includes identification information and other information specific to a particular ULD. Local and long range wireless tag readers positioned at various points within an aircraft can be used to identify the presence and specific real-time location of any ULD that is onboard an aircraft. Such a system can include one or more remote visual displays that present visual representations of the real-time locations of each ULD.

In rare instances, as ULDs are loaded and unloaded from an aircraft, the ULDs and/or their contents can be subject to unauthorized tampering, theft, vandalism, and the like. More frequently, the ULDs and/or their contents can be damaged during loading or unloading activities, or during transport. Such unauthorized activities and/or damage can be costly to air cargo carriers. Commonly, such unauthorized activities and/or damage may not be discovered until after a ULD reaches its destination. In addition, the cause or source of damage, theft, tampering, or vandalism to a ULD and/or its contents may not be apparent or discoverable once the damage, theft, tampering, or vandalism is discovered. In addition, an aircraft's cargo compartment and ULDs can sometimes be used by unauthorized persons to smuggle illicit items and materials.

Accordingly, there is a need for a system and method for surveying, monitoring, and recording activities and events that occur within an aircraft's cargo compartments, especially during loading and unloading activities. Preferably, such a system and method will assist air cargo carriers in determining the causes and/or sources of cargo tampering or damage, and will establish an evidentiary record of such activities and events. In addition, such a system and method preferably will be compatible with other onboard cargo loading and logistics systems, and even more preferably, will be integrated with such other onboard cargo systems.

### SUMMARY

The invention includes an integrated system for an aircraft having at least one cargo compartment. The system includes a cargo loading processor and a plurality of power drive units within the cargo compartment, each power drive unit being coupled to the cargo loading processor. The system also includes a video processor, and at least one video camera within the cargo compartment, the camera being coupled to the video processor. A central processor in communication with the cargo loading processor and the video processor is operable to receive information from both the cargo loading processor and from the video processor.

The invention also includes a method of controlling and monitoring activity within a cargo compartment of an aircraft. The method includes controlling at least some movement of cargo within the cargo compartment from a control location that is outside the cargo compartment, and displaying a video image of the cargo compartment proximate to the control location.

The invention further includes a cargo system for an aircraft. The system includes means for controlling movement of cargo within a cargo compartment of the aircraft from a control location that is outside the cargo compartment. The system also includes means for capturing images of activity within the cargo compartment, and means for displaying the images and for displaying status information related to the movement of cargo at the control location.

The invention further includes a monitoring system for an aircraft having at least one cargo compartment. The system includes at least one camera including a lens, and having at least a portion of the cargo compartment within its field of view. The system further includes a structure that substantially conceals the camera such that the lens is substantially undetectable from within the cargo compartment, and at least one display coupled to the camera that is operable to display an image from the camera.

The invention also includes an aircraft cargo monitoring system that includes a display configured to selectively display cargo loading or unloading status information and at least one video image of a cargo compartment. The invention further includes an aircraft cargo monitoring system including a plurality of video cameras positioned within a cargo compartment of an aircraft, wherein the combined fields of view of the plurality of cameras include substantially all portions of the cargo compartment.

These and other aspects of the invention will be understood from a reading of the following detailed description together with the drawings.

### BRIEF DESCRIPTION OF THE DRAWINGS

FIG. 1 is side view of a typical cargo aircraft showing the aircraft's cargo compartments.

FIG. 2 is a cross sectional view of the aircraft shown in FIG. 1 taken along line 2-2 in FIG. 1.

FIG. 3 is a front view of a typical aircraft Master Cargo Control panel.

FIG. 4 is a front view of a typical aircraft Cargo Control Panel.

FIG. 5 is a cross sectional view of a cargo aircraft showing possible camera locations within the aircraft's main deck and lower lobe cargo compartments.

FIGS. 6-8 are plan views of an aircraft's main deck cargo compartment showing various combinations of main deck camera locations.

FIGS. 9-12 are plan views of an aircraft's forward and aft lower lobe cargo compartments showing various combinations of main deck camera locations.

FIG. 13 is a perspective view of a compact video camera.

FIG. 14 is a perspective view of a portion of an aircraft lower lobe cargo compartment showing a video camera like that shown in FIG. 13 installed in a compartment sidewall.

FIG. 15 is a cross sectional view showing a video camera installed in a typical aircraft MCP tub.

FIG. 16 is a cross sectional view showing a video camera installed in a typical aircraft LCP tub.

FIG. 17 is a cross sectional view showing a video camera installed in a typical aircraft lower lobe CMDU tub.

FIG. 18 is a block diagram showing one embodiment of an integrated cargo loading and cargo video monitoring system according to the invention.

FIG. 19 is a perspective view of one embodiment of a cargo video server for use in the system shown in FIG. 19.

FIG. 20 is a perspective view of a control panel portion of the cargo video server shown in FIG. 19.

FIGS. 21A and 21B are cross-sectional views showing one installation of a cargo video server like that shown in FIGS. 19 and 20 in a sidewall of an aircraft cargo compartment.

FIG. 22 is a front view of a cargo control display screen.

FIG. 23 is a front view of a cargo video display screen.

FIG. 24 is a front view of a display screen that shows both cargo video images and cargo loading information.

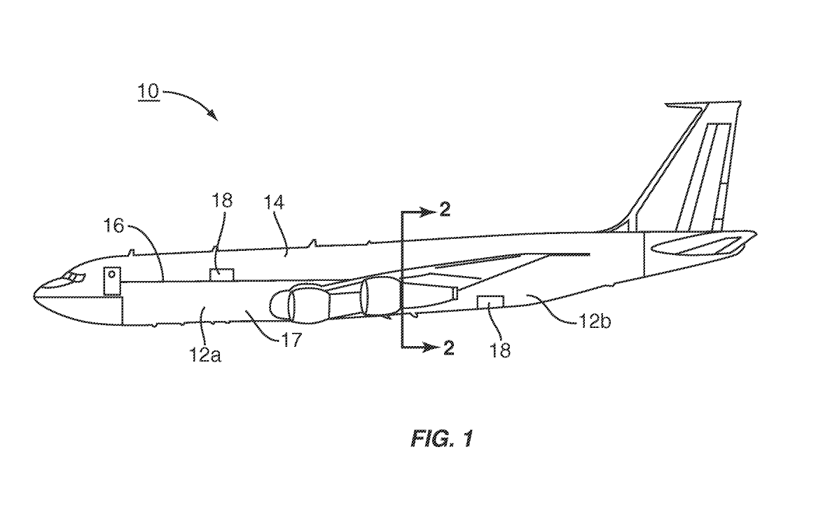

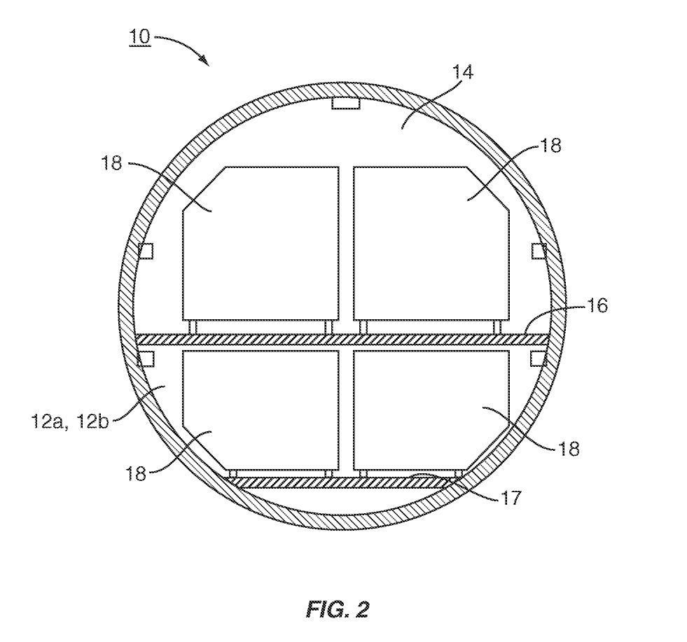

### DETAILED DESCRIPTION

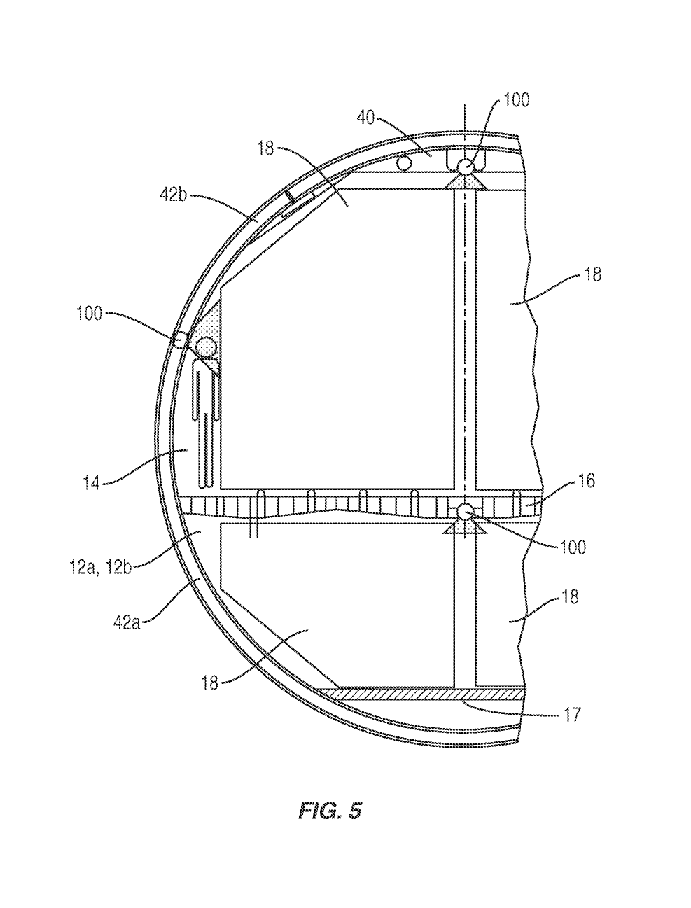

As shown in FIGS. 5-12, a system and method according to the invention includes one or more cameras 100 strategically positioned within an aircraft cargo compartment, such as in a forward lower lobe 12a, an aft lower lobe 12b, or a main deck cargo compartment 14. As shown in FIG. 5, in one embodiment, a camera 100 can be mounted in or on a ceiling 40, 16, and/or in or on a sidewall 42a, 42b of a cargo compartment 12a, 12b, 14. As shown in FIG. 5, when a camera 100 is mounted in or on an upper portion of a sidewall 42a, 42b, the camera 100 may be slightly tilted downward, such as about twenty degrees below horizontal, for example. In one embodiment, a plurality of cameras 100 are positioned within each of the cargo compartments 12a, 12b, 14 such that the combined fields of view of the plurality of cameras 100 at least include a substantial portion of each one of the cargo compartments 12a, 12b, and 14. Preferably, the cameras 100 are positioned such that a substantial portion of each unloaded region of a cargo compartment 12a, 12b, and 14 remains visible by at least one camera 100 as the aircraft is loaded and unloaded. If a cargo compartment normally is loaded such that one or more loaded ULDs will at least partially obstruct the field of view of at least one camera 100 within the cargo compartment, it is desirable to have at least one additional camera 100 that remains unobstructed by such loaded ULDs, and includes a substantial portion of remaining unloaded regions of the cargo compartment within its field of view.

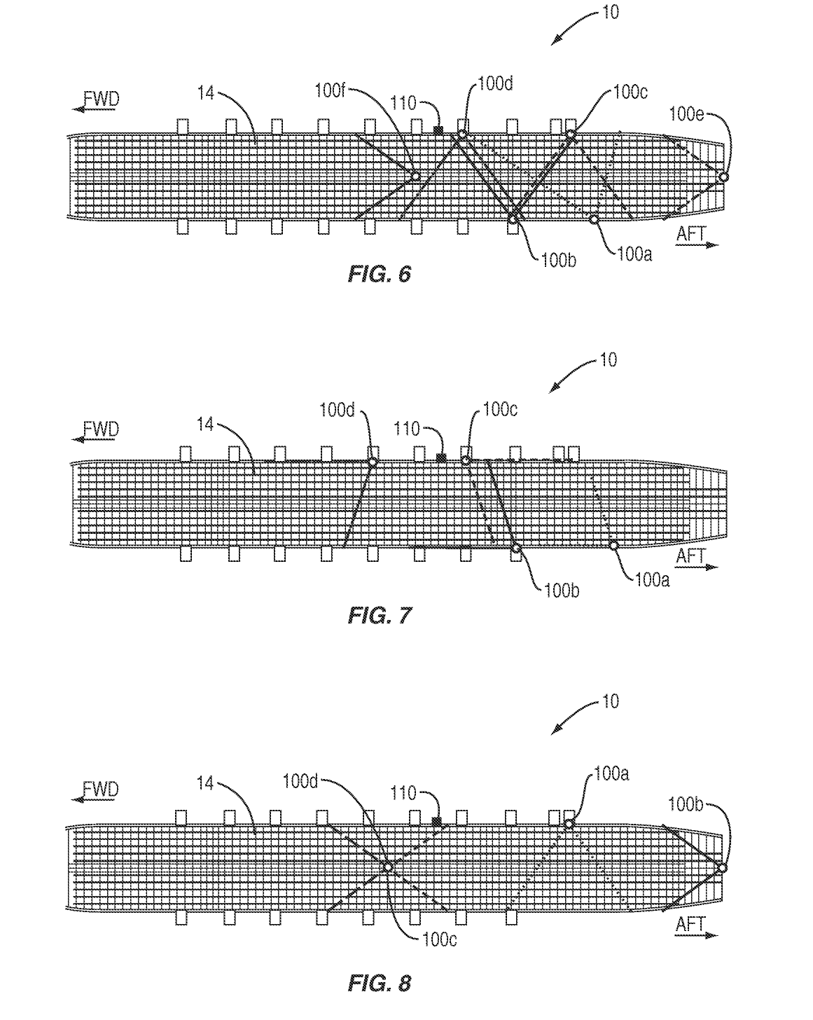

FIG. 6 shows one arrangement of six cameras 100a-100f positioned at various locations within a main deck cargo compartment 14 of an aircraft 10. In this arrangement, a first camera 100a is positioned on a left sidewall in an aft portion of the compartment 14. The field of view of the first camera 100a (and field of view of each of the other cameras 100b-100h described below) is within an acute angle formed by the two lines shown radiating from the camera's location. In the arrangement shown, the first camera 100a is angled approximately twenty degrees toward the forward end of the compartment 14. As also shown in FIG. 6, the second, third, and fourth cameras 100b-100d are staggered along left and right sidewalls of aft portions of the cargo compartment 14. The second, third, and fourth cameras 100b-100d each are generally pointed toward an opposite sidewall. A fifth camera 100e is mounted in the ceiling at the aft end of the main deck cargo compartment 14, and a sixth camera 100f is mounted in the ceiling at about a longitudinal midpoint of the compartment 14. In this arrangement, the sixth camera 100f is positioned such that the camera 100f can view substantially the entire forward portion of the cargo compartment 14 as ULDs are loaded from forward to aft. Similarly, the fifth camera 100e is positioned such that the camera 100e can view aft portions of the cargo compartment 14 as ULDs are loaded from forward to aft. The sidewall-mounted cameras 100a-100d are positioned such that at least one of the cameras 100a-100d is capable of viewing substantially any portion of the aft region of the cargo compartment 14 as freight is loaded into the aft region, though the field of view of one or more other cameras may be obstructed by one or more loaded ULDs.

FIG. 7 shows an alternative arrangement of a plurality of cameras 100a-100d within a main cargo compartment 14 of an aircraft 10. In this arrangement, four rather than six cameras 100 are positioned at various locations within the compartment 14. A first camera 100a is positioned on a left sidewall in an aft portion of the compartment 14. In the arrangement shown, the first camera 100a is angled approximately thirty-five degrees toward the forward end of the compartment 14. As also shown in FIG. 7, the second camera 100b and third camera 100c are staggered along left and right sidewalls of aft portions of the cargo compartment 14, and also are angled about thirty-five degrees in a forward direction. A fourth camera 100d is mounted in or on a right sidewall at about a longitudinal midpoint of the compartment, and is offset approximately thirty-five degrees toward the forward end of the compartment 14. In this arrangement, no ceiling-mounted cameras 100 are used.

Still another arrangement of cameras 100a-100d within a main deck cargo compartment 14 of an aircraft 10 is shown in FIG. 8. In this arrangement, a first camera 100a is positioned along a right sidewall in an aft portion of the compartment 14, and has no forward or aft offset. A second camera 100b is mounted in or on a ceiling at or near an aft end of the compartment 14, and is directed in a forward direction. A third camera 100c and a fourth camera 100d are mounted in or on a ceiling near a midpoint of the compartment 14, and are respectively directed in aft and a forward directions.

Accordingly, as indicated in FIGS. 6-8, various numbers, positions, and angles of cameras 100 can be provided for viewing various regions of a main deck cargo compartment 14. All such configurations are designed, however, to provide substantially unobstructed views of substantial portions of all unoccupied regions of the main deck compartment 14 during loading and unloading of ULDs. As shown in FIG. 5, the cameras 100 also provide views of at least some regions between and around stowed ULDs 18.

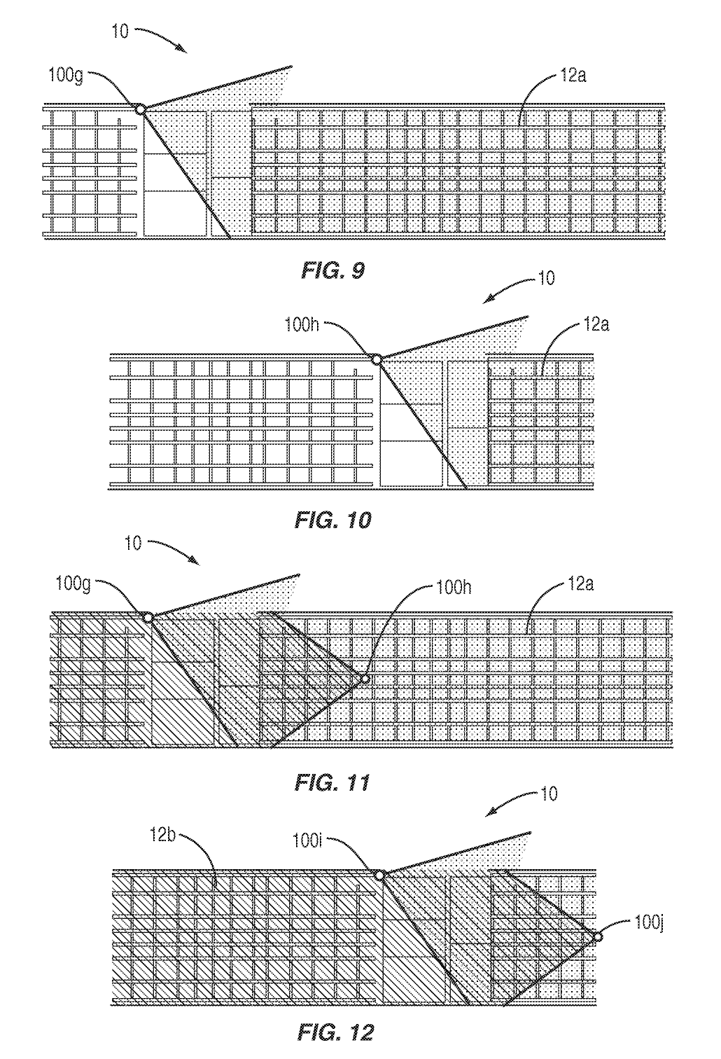

FIGS. 9-12 show several different of arrangements of cameras within forward and aft lower lobes 12a, 12b of an aircraft 10. In FIGS. 9 and 12, a first lower lobe camera 100g is positioned in or on a sidewall in a forward portion of a forward lower lobe cargo compartment 12a. As shown in FIG. 9, the first lower lobe camera 100g can be angled toward the aft end of the lower lobe 12a. As shown in FIG. 10, a second lower lobe camera 100h is positioned along a right sidewall of the aft lobe compartment 12b, and is angled toward an aft direction. The first and second lower lobe cameras 100g, 100h combine to provide views of substantially all regions of the forward and aft lower lobes 12a, 12b during cargo loading and unloading.

In another lower lobe camera arrangement shown in FIGS. 11 and 12, the forward lobe compartment 12a includes a first lower lobe camera 100g that is positioned and angled substantially the same as the first lower lobe camera shown in FIG. 9. In this arrangement, however, a ceiling-mounted second lower lobe camera 100h is provided for viewing the forward most regions of the forward lobe 12a. As shown in FIG. 12, the aft lobe compartment 12b can include a third lower lobe camera 100i that is positioned and angled substantially the same as the second lower lobe camera 100h shown in FIG. 10. In this arrangement, however, a ceiling-mounted fourth lower lobe camera 100j also is provided for viewing the forward most regions of the aft lobe 12b.

The total number of cameras 100 provided within a main deck cargo compartment 14 and within associated lower lobe compartments 12a, 12b can depend on a number of factors. For example, the total number of cameras 100 that can be installed within the cargo compartments 14, 12a, 12b of an aircraft 10 may be limited by the aircraft's power or weight constraints. The total number of cameras 100 also may be dictated by the capacity of one or more related video system components, such as by the input capacity of an associated video controller, or the like. In one embodiment, an aircraft cargo video system according the invention includes six-eight cameras 100 distributed between a main deck cargo compartment 14 and lower lobe cargo compartments 12a, 12b.

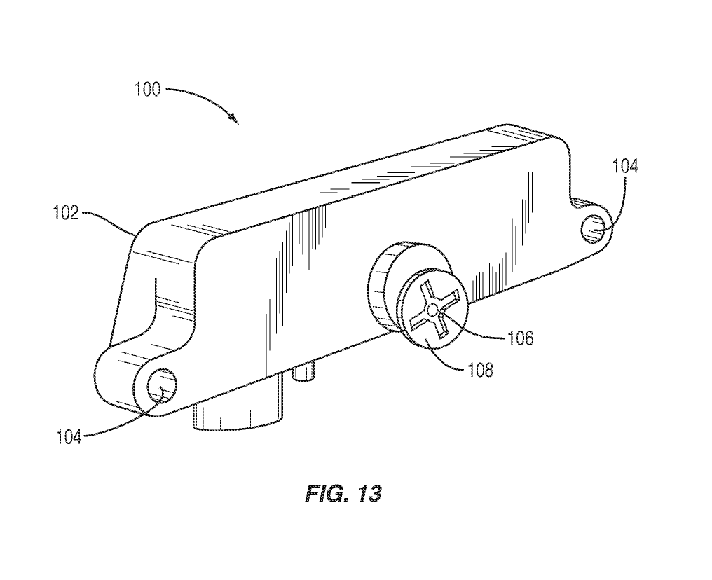

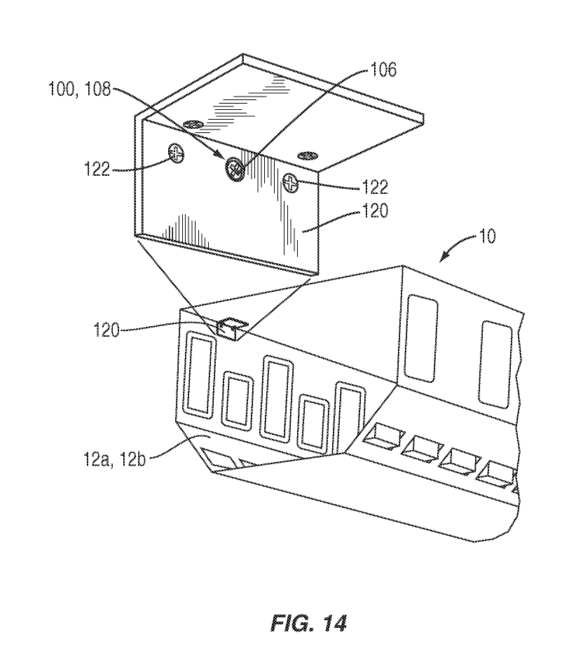

A system and method according to the invention may include cameras 100 that provide periodic still images of associated cargo compartments 12a, 12b, 14. In a preferred embodiment, however, the cameras 100 are video cameras capable of providing continuous live video images of their associated cargo compartments 12a, 12b, 14. One embodiment of a video camera 100 suitable for use in the present invention is shown in FIG. 13. In this embodiment, the camera 100 includes a housing 102 having one or more holes 104 for receiving bolts or screws or the like (not shown) for mounting the camera 100 to an aircraft. The camera 100 can include a small lens or aperture 106. In the embodiment shown, the lens or aperture 106 is disposed at the center of a simulated fastener head 108 that at least partially camouflages the lens or aperture 106 from view. The camera 100 is provided with a suitable connector 110 for electrically connecting the camera 100 to a compatible video controller. Preferably, the camera 100 is compact and lightweight. In the embodiment shown in FIG. 13, the camera 100 is less than about six inches long, is about 2 inches tall, is less than about two inches deep, and weighs less than about 0.5 lb.

In one embodiment, the camera 100 is an NTSC format video camera with about 575 TV lines resolution. The camera 100 preferably conforms to RTCA/DO-160 environmental and electrical requirements, and meets or exceeds aircraft flammability requirements. Preferably, the camera 100 has low light capability that provides high quality video images at normal cargo compartment illumination levels. In one embodiment, the camera 100 has a CCD rating of about 0.003 lux, and is capable of capturing satisfactory images at illumination levels as low as about 0.1 lux. Optionally, the camera 100 may include infrared capability for detecting heat sources in extreme low-light conditions. The camera 100 also may include a heated lens assembly that substantially prevents the camera's lens from being obscured by condensation or frost. The camera 100 is designed to endure rigorous in-flight conditions, and preferably has a mean time between failures (“MTBF”) of at least about 30,000 hours. In one embodiment, each camera 100 has a field of view between about seventy degrees and about ninety degrees. Alternatively, a camera 100 can have smaller or larger viewing angle for a specific camera application or camera location.

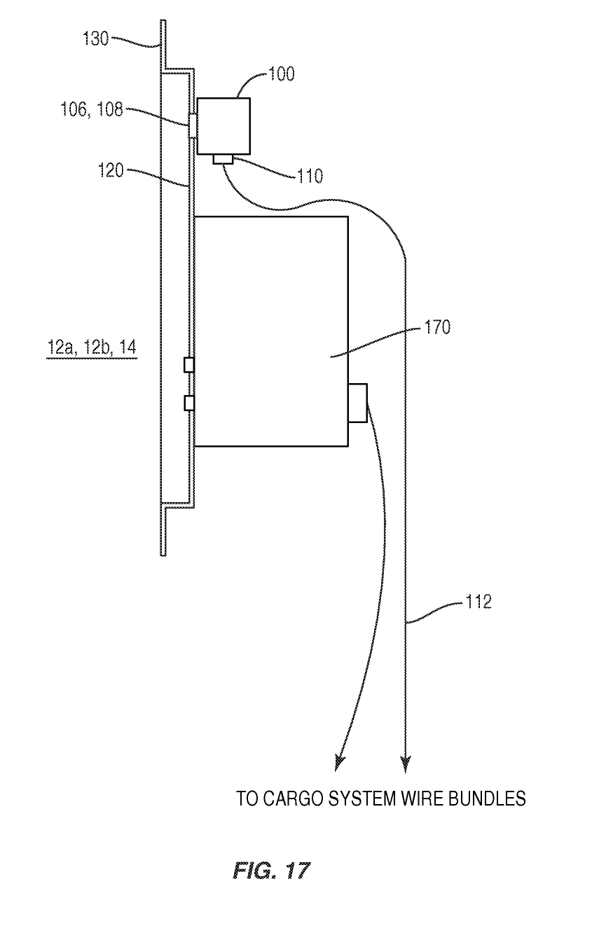

FIGS. 14-17 show various arrangements for mounting a camera 100 like that described above along a sidewall of an aircraft cargo compartment 12a, 12b, 14. As shown in FIG. 14, a camera 100 can be mounted behind a concealment panel 120 located on an upper portion of a sidewall of a lower lobe cargo compartment 12a, 12b of an aircraft 10. The camera 100 can be mounted on a rear side of the panel 120 by one or more mechanical fasteners 122. The simulated fastener head 108 may extend through the panel 120, and may be configured such that it has substantially the same appearance as the exposed heads of the fasteners 122. Though the bulk of the camera 100 is hidden from view behind the panel, the lens or aperture 106 is exposed to an interior portion of the lower lobe cargo compartment 12a, 12b. A similar arrangement can be used to mount and conceal a camera 100 within a main deck cargo compartment 14 (not shown in FIG. 14). Because the camera 100 is substantially hidden from view from within a cargo compartment 12a, 12b, 14, persons within the cargo compartment will not recognize the camera 100 is present, and thus will not tamper with, obstruct, or intentionally avoid the camera 100.

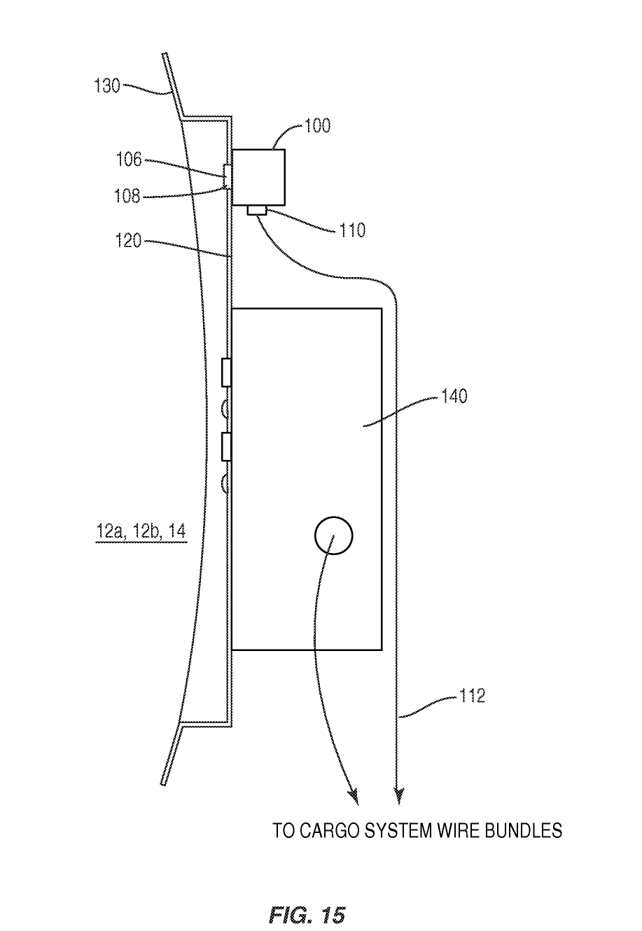

FIG. 15 shows one arrangement for mounting a camera 100 within a Master Control Panel (“MCP”) tub 130 of a type commonly mounted along a sidewall of an aircraft cargo compartment 12a, 12b, 14. In this arrangement, a concealment panel 120 and camera 100 connected thereto are mounted to the MCP tub 130 above the MCP unit 140. The connector 110 of the camera 100 can be connected by a camera cable or cables 112 to a power source and/or one or more other system components as further described below. The camera 100 is electrically isolated from the MCP 140.

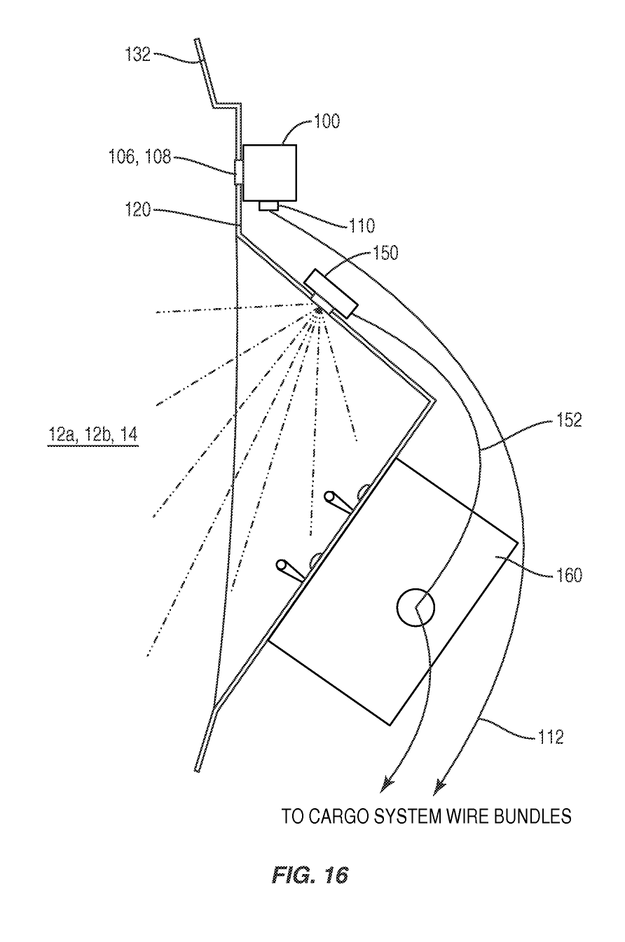

FIG. 16 shows one arrangement for mounting a camera 100 within a Local Control Panel (“LCP”) tub 132 of a type commonly mounted along a sidewall of an aircraft cargo compartment 12a, 12b, 14. In this arrangement, a concealment panel 120 and camera 100 connected thereto are mounted to the LCP tub 132 above the LCP unit 160. As shown in FIG. 16, the camera 100 can be positioned proximate to a light source 150 connected to the LCP 160 by wires or cable 152. Again, the connector 110 of the camera 100 can be connected by a camera cable or cables 112 to a power source and/or one or more other system components as further described below. The camera 100 is electrically isolated from the LCP 160. Though not shown, the embodiment shown in FIG. 15 and described above may also include a light source like that shown in FIG. 16.

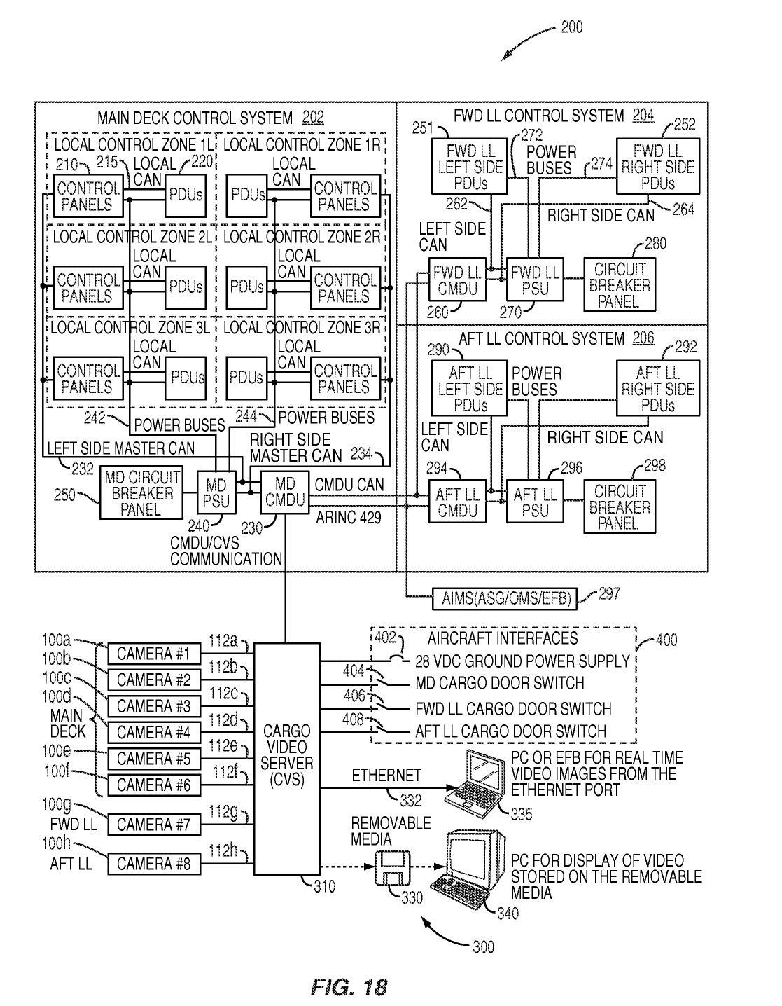

FIG. 18 shows one arrangement of mounting a camera 100 within a Cargo Maintenance Display Unit (“CMDU”) tub 134 of a type commonly mounted along a sidewall of an aircraft cargo compartment 12a, 12b, 14. In this arrangement, a concealment panel 120 and camera 100 connected thereto are mounted to the CMDU tub 134 above the CMDU unit 170. As described above, the connector 110 of the camera 100 can be connected by one or more camera cables 112 to a power source and/or one or more other system components as further described below. The camera 100 is electrically isolated from the CMDU 170.

FIG. 18 shows one embodiment of an integrated cargo loading and cargo video monitoring system 200 according to the invention. In this embodiment, the system 200 includes a main deck cargo control subsystem 202, a forward lower lobe cargo control subsystem 204, an aft lower lobe cargo control subsystem 206, and a cargo video monitoring/recording subsystem 300. In this embodiment, the cargo video monitoring/recording subsystem 300 includes eight cameras 100a-100h distributed about a main deck cargo compartment 14, a forward lower lobe cargo compartment 12a, and an aft lower lobe cargo compartment 12b like the camera placements shown in FIGS. 6, 9 and 10, for example. The cargo video monitoring/recording subsystem 300 also can include more or fewer cargo compartment cameras 100.

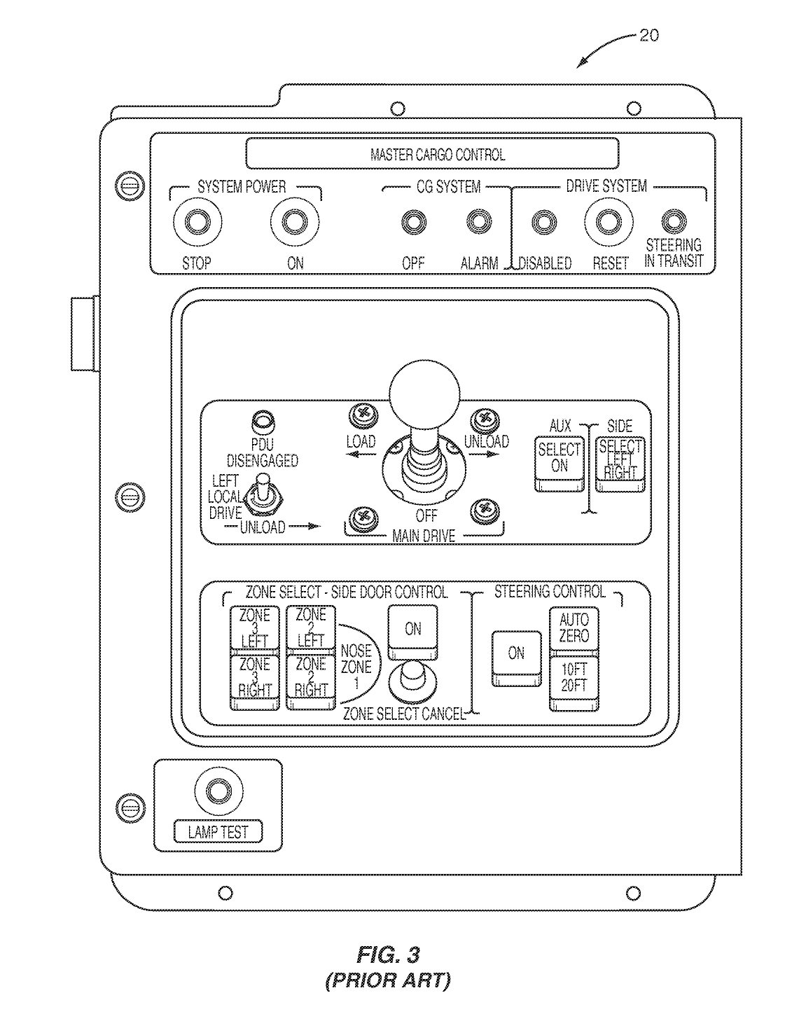

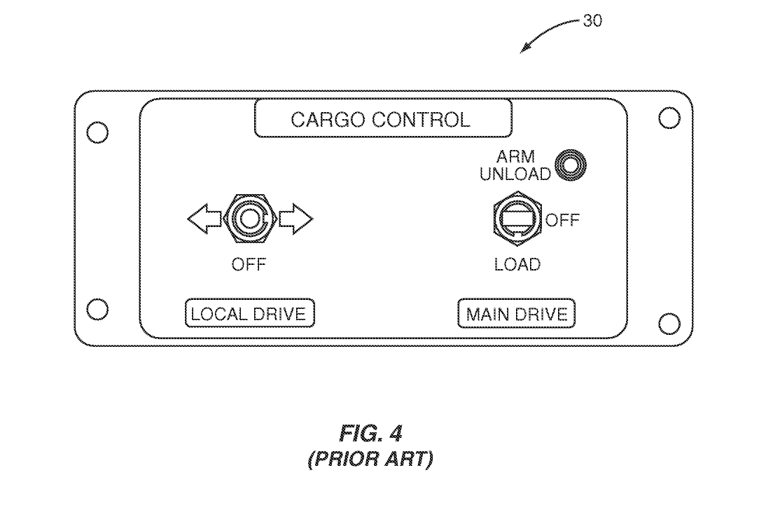

As shown in FIG. 18, the main deck cargo control subsystem 202 can include a plurality of PDUs 220 located within various zones on the main cargo deck. For example, in FIG. 18, the main deck cargo control subsystem 202 includes six local control zones. Each local control zone includes a plurality of local main deck PDUs 220 connected by a local controller area network (“CAN”) 215 to a local main deck control panel 210. In this embodiment, each main deck PDU 220 and each main deck local control panel 210 is connected to and powered by a main deck Power Supply Unit (“PSU”) 240 via power buses 242, 244. The main deck PSU 240 can be governed by a main deck circuit breaker 250. Each main deck local control panel 210 can be configured to permit selective control and operation of each main deck PDU 220 to which it is connected. In one embodiment, each main deck control panel 210 is coupled to a main deck Cargo Maintenance Display Unit (“CMDU”) 230 that is configured to selectively display information relating to the operation and status of the main deck cargo control subsystem 202. The main deck CMDU 230 also is configured to permit selective control of each of the main deck local control panels 210 and main deck PDUs 220. The main deck CMDU 230 also is powered by the main deck PSU 240. The main deck CMDU 230 is located at a convenient location within the main deck cargo compartment 14. For example, the main deck CMDU 230 can be positioned proximate to a master cargo control panel 20 like that shown in FIG. 3.

As shown in FIG. 18, the integrated system 200 also includes a forward lower lobe cargo control subsystem 204. In the embodiment shown, subsystem 204 includes a plurality of left side forward lower lobe PDUs 251, and a plurality of right side forward lower lobe PDUs 252. The left and right side PDUs 251, 252 are respectively coupled to and controlled by a forward lower lobe CMDU 260 via left and right side CANs 262, 264. The forward lower lobe PDUs 251, 252 can be connected to and powered by a forward lower lobe PSU 270 via power buses 272, 274. The PSU 270 is governed by a forward lower lobe circuit breaker 280, and powers the forward lower lobe CMDU 260. The forward lower lobe CMDU 260 is operable to selectively control operation of the forward lower lobe PDUs 251, 252, and to selectively display information relating to the operation and status of the PDUs 251, 252.

As also shown in FIG. 18, the aft lower lobe cargo control subsystem 206 can be similarly configured to the forward lower lobe cargo control subsystem 204 described above. The aft lower lobe cargo control subsystem 206 can include left and right side aft lower lobe PDUs 290, 292, an aft lower lobe CMDU 294, an aft lower lobe PSU 296, and an aft lower lobe circuit breaker 298. The aft lower lobe CMDU 294 is operable to selectively control operation of the aft lower lobe PDUs 290, 292, and to selectively display information relating to the operation and status of the PDUs 290, 292.

As also shown in FIG. 18, each of the main deck and lower lobe CMDUs 240, 260, 294 can be coupled to an airplane information management system (“AIMS”) 297, such as by an ARINC 429 data bus interface 292 or the like. The AIMS 297 can be a permanent portion of the aircraft, such as an Onboard Maintenance System (“OMS”), or can be a portable electronic flight bag (EFB). The system 200 also can include one or more additional communication interfaces, such as an ARINC Signal Gateway (“ASG”), or the like. The AIMS 297 can enable authorized persons with access to an aircraft's information systems and who are remote from the aircraft's CMDUs to remotely monitor an aircraft's cargo compartments. For example, the AIMS 297 can enable a flight crew to visually monitor the condition of a cargo compartment before, during or after flight, such that appropriate action, if any, can be taken.

FIG. 18 also shows a cargo video monitoring and recording subsystem 300 integrated with the cargo control subsystems 202, 204, 206 described above. As shown in FIG. 18, the video subsystem 300 includes a cargo video server (“CVS”) 310 coupled to the main deck CMDU 230. A plurality of video cameras 100a-100h each are respectively connected to the CVS 310 by a plurality of video cables or wires 112a-112h. For example, the six main deck cameras 100a-100f shown in FIG. 18 can correspond to the six main deck cameras 100a-100h depicted in FIG. 6, and the two lower lobe cameras 100g, 100h shown in FIG. 18 can correspond to the two lower lobe cameras 100g, 100h depicted in FIGS. 9 and 10. Preferably, the system 200 is configured such that the cargo video monitoring and recording subsystem 300 can be powered and operational even when the cargo control subsystems 202, 204, 206 are off. Preferably, the video subsystem 300 consumes not more than about 50 Watts of power.

The CVS 310 also can be connected to one or more aircraft interfaces 400, such as to a ground power supply 402, a main cargo door switch 404, a forward lower lobe cargo door switch 406, and an aft lower lobe cargo door switch 408. The cargo door switches 404, 406, 408 can be configured to signal the CVS 310 to activate one or more of the video cameras 100a-100h only when a cargo door associated with a camera's cargo compartment is open. Alternatively, the CVS 310 can be activated by other types of automated sensors for detecting activity within a cargo compartment, such as by motion detectors, aircraft wheel weight sensors, or the like. The CVS 310 can include an Ethernet connection 332 for connecting the CVS 310 to a portable computer or electronic flight bag (“EFB”) 335, or to another electronic device capable of receiving video outputs from the CVS 310. In addition, the CVS 310 preferably is capable of recording video information on removable storage media 330 so that video image files can be saved and played later on a remote video-playing device, such as a PC 340.

Because the CVS 310 is coupled to the main deck CMDU 230 and the main deck CMDU 230 is in turn coupled to the forward and aft lower lobe CMDUs 260, 294, video signals received by the CVS 310 from any one of the main deck or lower lobe cargo compartment cameras 100a-100h can be selectively viewed on any of the cargo compartment CMDUs 230, 260, 294. Thus, the integrated cargo loading and video monitoring/recording system 200 permits a person or persons charged with supervising and controlling the loading or unloading of cargo onto/from an aircraft to: 1) control cargo loading/unloading activities from a single location: 2) monitor cargo loading/unloading activities from such location; and 3) view cargo compartment activities during cargo loading and unloading in real time from such location. In addition, if cargo is altered, damaged or missing, the system 200 provides recorded video evidence of substantially all loading and unloading activities within a particular cargo compartment, thereby permitting cargo carriers to better ascertain the cause or potential cause of such altered, damaged or missing cargo.

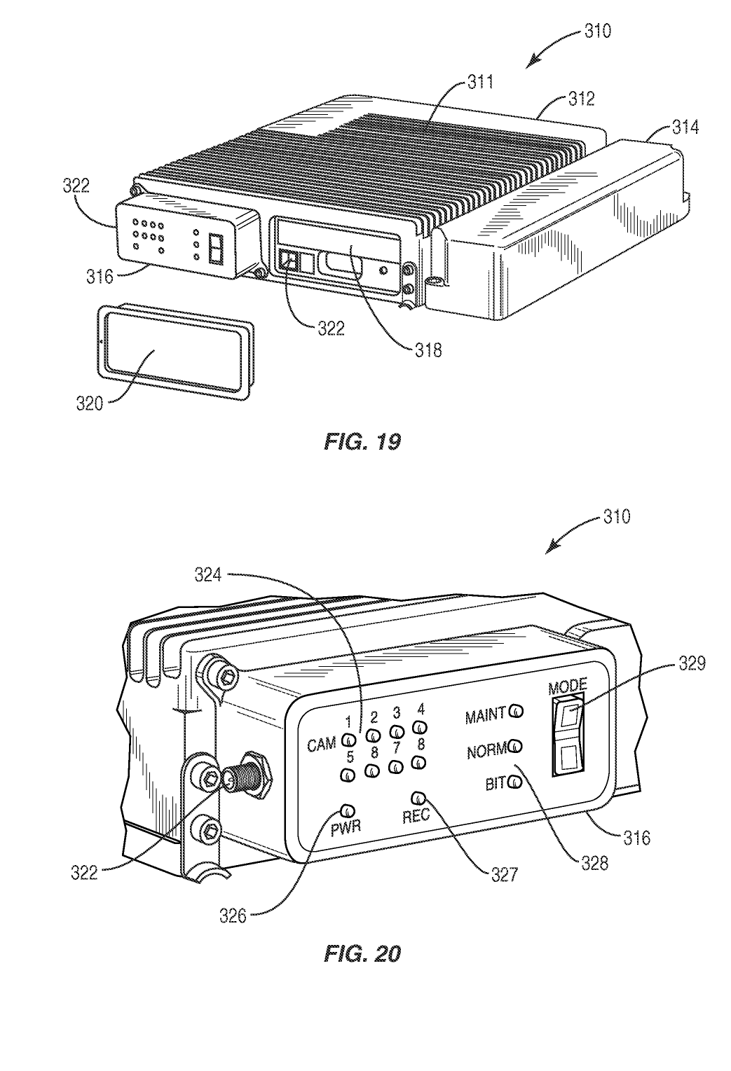

One embodiment of CVS 310 for use in the integrated system 200 described above is shown in FIGS. 19 and 20. As shown in FIG. 20, the CVS 310 can include a housing 312, and optionally can include a backup battery 314. The housing 312 may include a plurality of external cooling fins 311 to passively dissipate internally generated heat, and to eliminate the need for a power-consuming cooling fan. The front of the CVS 310 can include an integral control panel 316. The CVS 310 also can include an Ethernet port 332 (such as 100 Base-T Ethernet 4x), and a removable hard drive 318 or other removable storage medium 330 for storing video image data. Preferably, the storage media 318, 330 includes non-volatile memory capable of storing at least about 100 hours of recorded video data. For example, the removable hard drive 318 can have at least about 40 GB of non-volatile memory. Preferably, the hard drive 318 is a ruggedized, extended-temperature hard drive that is mounted within a sealed protective housing. Alternatively, the storage media 318, 330 can be any other type of storage device having adequate storage capacity and durability. In one embodiment, the CVS 310 records video data in motion JPEG format. The CVS 310 also may include a flash memory card, such as a 16 GB flash PC card or the like (not shown in FIGS. 19 and 20). A removable access cover 320 can selectively cover the hard drive 318 and Ethernet port 332. The CVS 310 also can include one or more external antennae connections 322 for use in wirelessly receiving and sending data or other information.

The CVS 310 can be equipped with a Pentium® M 1.6 GHz processor and have about one GB of internal memory. The CVS 310 can have up to about 1600×1200 LVDS video output, and accept eight or more NTSC video inputs. The CVS 310 also can include two or more NTSC video outputs. In one embodiment, the CVS 310 is operational between about −15 degrees C. and about +55 degrees C., and conforms to all applicable portions of RTCA/DO-160.

As shown in FIG. 20, the CVS control panel 316 can include a plurality of camera indicator lights 324, a power indicator light 326, a record indicator light 327, and/or one or more other status indicator lights 328. A mode switch 29 can be provided for selecting a desired mode of operation of the CVS 310. For example, the mode switch 29 may operable to selectively switch operation of the CVS 310 between a maintenance mode, a normal mode, and a built-in test equipment (“BITE”) mode.

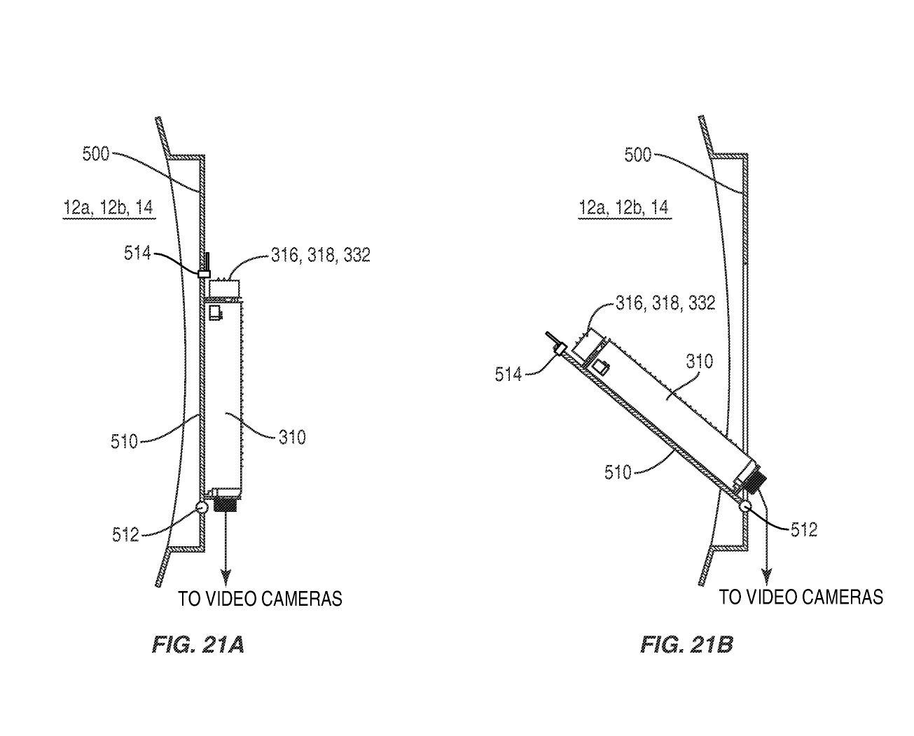

As shown in FIGS. 21A and 21B, the CVS 310 can be mounted to an interior surface of a movable panel 510 mounted to a tub 500 on an interior surface of a aircraft cargo compartment 12a, 12b or 14. For example, the CVS 310 can be located on a sidewall of a cargo compartment at a location that minimizes the distance between the CVS 310 and the most distant camera(s) 100. The movable panel 510 may be pivotally connected to the tub 500 by one or more hinges 512 such that the CVS 310 is stored away from view behind the panel 510 when the panel 510 is closed, and the control panel 316, removable storage media 318, and Ethernet connection 332 can selectively be accessed when the panel 510 is open. Preferably, the movable panel 510 substantially hides the CVS 310 such that unauthorized persons cannot access the CVS 310 or removable storage media 318. As shown in FIGS. 21A and 21B, the panel 510 may include one or more locks to further prevent unauthorized access to the CVS 310.

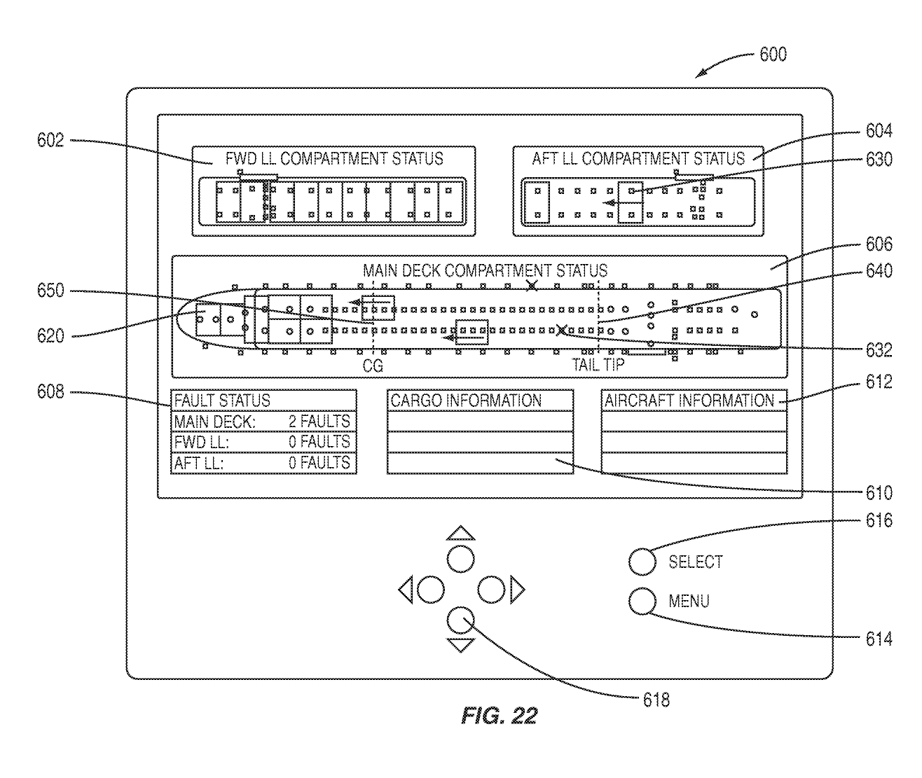

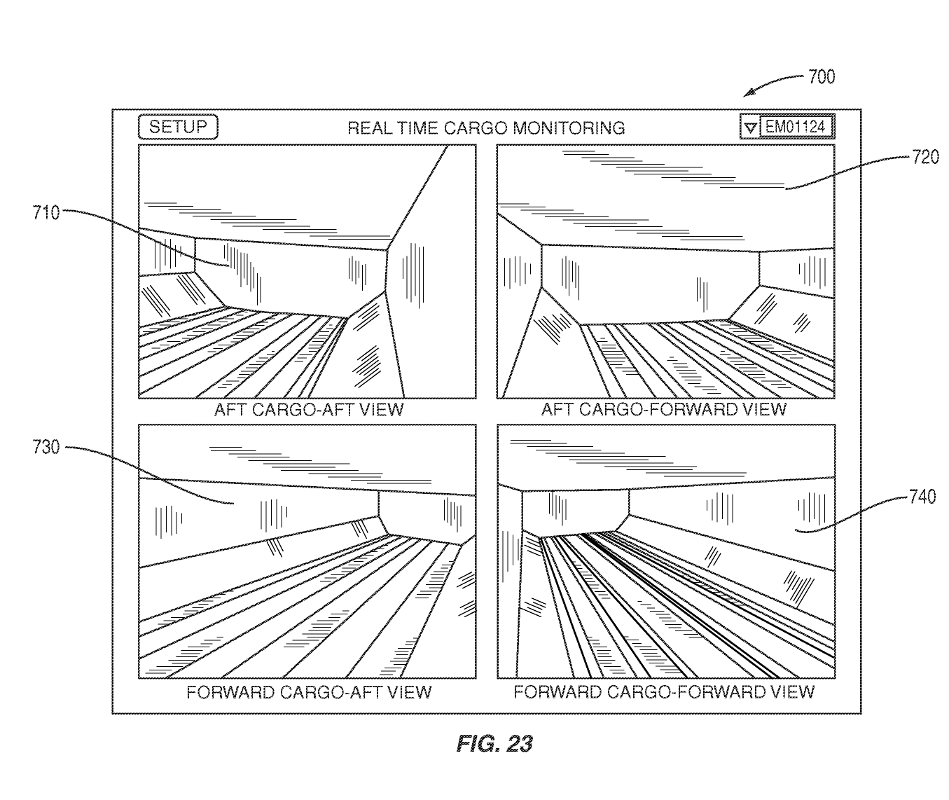

FIG. 23 shows one embodiment of a CMDU display screen 600 that may be selectively displayed on the main deck CMDU 230, forward lower lobe CMDU 260, and/or aft lower lobe CMDU 294 to display real-time status within the cargo compartments. As shown in FIG. 22, the display screen 600 can include simultaneous graphical representations of a main deck compartment 606, a forward lower lobe compartment 602, and an aft lower lobe compartment 604. The display may include graphic representations of one or more ULDs 620 that have been fully loaded in a particular cargo compartment, and may include graphic representations of the locations and directions of one or more ULDs 630 that presently are being moved to or from a stowage location within a particular cargo compartment. The cargo control portions 202, 204, 206 of the integrated system 200 can include one or more ULD-sensing PDUs to sense and track the current location of a particular ULD within an aircraft cargo compartment 12a, 12b. 14. For example, the system 200 can include one or more ULD-sensing PDUs as described in U.S. Pat. No. 6,834,758 to Goodrich Corporation.

In one embodiment, a particular ULD can be automatically identified to the system 200 as the ULD enters a cargo compartment 12a, 12b, 14. For example, each ULD can include a unique barcode identification tag that is scanned by a barcode reader as the ULD enters a cargo compartment 12a, 12b, 14, and the detected identification information (such as a unique ULD identification number) and other information specific to the identified ULD (such as ULD contents, ULD weight, cargo compartment location, and the like) can be communicated to the system 200 by the barcode reader. Alternatively, each ULD can include an RFID tag with stored ULD identity information and other ULD information that is operable to communicate the ULD information to the system 200 via an RFID reader. For example, the identity, location, and characteristics of a tagged ULD can be initially detected by an RFID reader as the tagged ULD enters a cargo compartment 12a, 12b, 14, and can be communicated to the system 200 by the RFID reader. In one embodiment, the system can include a RFID identification and tracking system like that described in published U.S. Patent Application No. 2006/0038077 A1, assigned to Goodrich Corporation. In such a system 200, RFID readers can be positioned within each cargo compartment 12a, 12b, 14 to detect the identities, real-time locations, and characteristics of tagged ULDs as the ULDs are loaded or unloaded from an aircraft's cargo compartment 12a, 12b, 14.

As shown in FIG. 23, the CMDU display screen 600 can display include other graphic representations, such as the location of a faulty or inactive PDU 632, an indication of a current “tail tip” boundary 640 beyond which ULDs should not be moved, an indication of a current aircraft center of gravity (“CG”) 650 based on the positions of currently stowed ULDs, and the like. In order to display the tail-tip and CG information, the system can be coupled to an automated aircraft weight and balance system of a type known to persons of ordinary skill in the art. In addition, the display 600 can include other current information regarding equipment fault status 608, other cargo information 610, other aircraft information 612, and the like. In one embodiment, one or more of the cargo compartment CMDUs 230, 260, 294 can include a touch screen operable to detect touch commands from a user. As shown in FIG. 22, the display screen 600 can include a touch screen menu “button” for selecting a menu of user options, a touch screen select “button” for selecting a particular user option, a series of navigation “buttons” 618 for moving a cursor or navigating a menu, and the like.

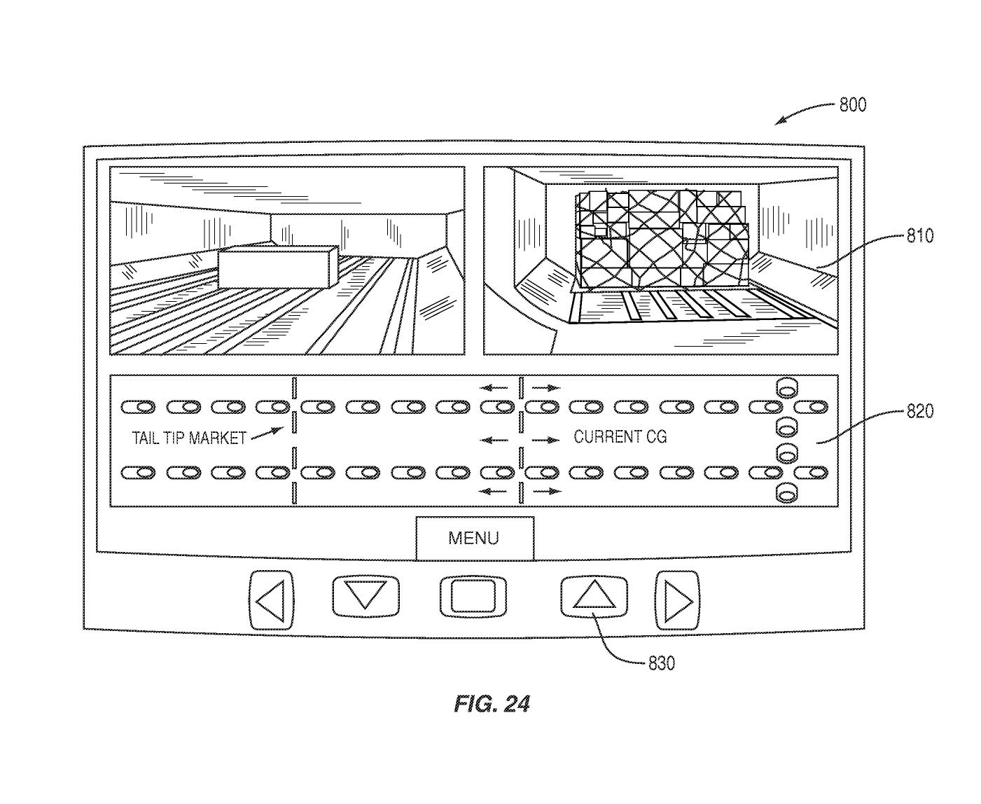

FIG. 23 shows another embodiment of a CMDU display screen 700 that may be selectively displayed on the main deck CMDU 230, forward lower lobe CMDU 260, and/or aft lower lobe CMDU 294 to display real-time video images of one or more of an aircraft's various cargo compartments. In the display 700 shown in FIG. 23, the display 700 includes four real time video images, including: 1) an aft view 710 of an aft lower lobe cargo compartment; 2) a forward view 720 of an aft lower lobe cargo compartment; 3) an aft view 730 of a forward lower lobe cargo compartment; and 4) a forward view of a forward lower lobe cargo compartment. Of course, a system 200 according to the invention can be configured to selectively display substantially any single video image or any combination of video images from any one of its video cameras 100. In addition, as shown in FIG. 24, the system 200 can be configured to display a screen 800 that includes a combination of one or more video images 810, one or more graphical cargo information displays 820, and one or more navigation buttons 830.

FIG. 24 shows one embodiment of a video display screen 800 presented on a remote ground-based device, such as a personal computer 340. The computer 340 can include compatible software to enable it to display video data recorded by the CVS 310. For example, the video display screen 800 shown in FIG. 24 is being played from a removable storage medium 330 on which video data has been recorded by the CVS 310. As shown in FIG. 24, an integrated system 200 according to the invention can enable a person to selectively review recorded video data from a particular cargo compartment at a particular time for the occurrence of a particular activity or event. The video display screen 800 can include pertinent information such as the identity of an associated aircraft 810, the date 812 and time 814 of a particular video recording, one or more other corresponding cargo compartment video images 816, and one or more touch screen video control “buttons” 818 for navigating a video recording, or the like.

The above descriptions of various embodiments of the invention are intended to illustrate and describe various aspects of the invention. Persons of ordinary skill in the art will recognize that various modifications can be made to the described embodiments without departing from the invention. For example, though the invention has been principally described in connection with an aircraft having both main deck and lower lobe cargo compartments, the invention also can be used on an aircraft having only lower lobe cargo compartments. All such modifications are intended to be within the scope of the appended claims.

What is claimed is:

1. An integrated system for an aircraft that includes at least one cargo compartment, the system comprising:
(a) a cargo loading processor;
(b) a plurality of power drive units within the cargo compartment, each power drive unit being coupled to the cargo loading processor;
(c) a video processor;
(d) at least one video camera within the cargo compartment, the camera being coupled to the video processor; and
(e) a central processor in communication with the cargo loading processor and the video processor, the central processor being operable to receive information from both the cargo loading processor and from the video processor.

2. An integrated system according to claim 2 wherein the central processor comprises a display configured to selectively display information received from the cargo loading processor and to selectively display information received from the video processor.

3. An integrated system according to claim 1 wherein the camera is substantially undetectable from within the cargo compartment.

4. An integrated system according to claim 1 wherein the video processor is operable to record image data received from the video camera.

5. An integrated system according to claim 1 wherein the video processor includes a removable storage media.

6. An integrated system according to claim 1 wherein the aircraft includes at least a first cargo compartment and a second cargo compartment, the video camera is positioned within the first cargo compartment, and the central processor is positioned within the second cargo compartment.

7. An integrated system according to claim 1, and further comprising at least one sensor operable to detect an activity or an event within the cargo compartment, and to activate the video camera in response to the detected activity or event.

8. An integrated system according to claim 7 wherein the activity or event is selected from the group consisting of motion, cargo door displacement, and changes in aircraft weight.

9. A method of controlling and monitoring activity within a cargo compartment of an aircraft, the method comprising:
(a) controlling at least some movement of cargo within the cargo compartment from a control location that is outside the cargo compartment; and
(b) displaying a video image of the cargo compartment proximate to the control location.

10. A method according to claim 9 and further comprising recording video images of the cargo compartment.

11. A method according to claim 9 wherein controlling at least some movement of cargo within the cargo compartment comprises controlling at least one power drive unit within the cargo compartment.

12. A method according to claim 9 and further comprising automatically detecting the location of at least one cargo unit within the cargo compartment, and communicating the cargo unit location to the control location.

13. A cargo system for an aircraft comprising:
(a) means for controlling movement of cargo within a cargo compartment of the aircraft from a control location that is outside the cargo compartment;
(b) means for capturing images of activity within the cargo compartment; and
(c) means for displaying the images and for displaying status information related to the movement of cargo at the control location.

14. A cargo system according to claim 13 wherein the means for controlling movement of cargo comprises:
(a) at least one power drive unit within the cargo compartment;
(b) a control panel at the control location coupled to the power drive unit.

15. A cargo system according to claim 13 wherein the means for capturing images of activity within the cargo compartment comprises at least one video camera.

16. A cargo system according to claim 15 wherein the video camera is substantially undetectable from within the cargo compartment.

17. A cargo system according to claim 13 wherein the means for displaying the images and for displaying information related to the movement of cargo at a remote location comprises a display screen operable to display graphics and to display video.

18. A monitoring system for an aircraft having at least one cargo compartment, the system comprising:
(a) at least one camera including a lens and having at least a portion of the cargo compartment within its field of view;
(b) a structure that substantially conceals the camera such that the lens is substantially undetectable from within the cargo compartment;
(c) at least one display coupled to the camera that is operable to display an image from the camera.

19. A monitoring system according to claim 18 wherein the structure that substantially conceals the camera comprises an imitation fastener having an aperture aligned with the lens.

20. A monitoring system according to claim 18 wherein the camera is a video camera, and further comprising a video server coupled to the camera and coupled to the display.

21. A monitoring system according to claim 20 wherein the video server is operable to record video images received from the camera.

22. A monitoring system according to claim 18 wherein the video server includes a removable video storage device.

23. A monitoring system according to claim 18 wherein the aircraft includes at least a first cargo compartment and a second cargo compartment, the camera is positioned within the first cargo compartment, and the display is positioned within the second cargo compartment.

24. A monitoring system according to claim 20, and further comprising a cargo control system comprising a plurality of power drive units, wherein the video server and the power drive units both are coupled to a common control processor.

25. A monitoring system according to claim 20, wherein the display is configured to selectively display video images from the video camera, and to selectively display information relating to a status of the cargo control system.

26. A monitoring system according to claim 18, and further comprising at least one cargo activity sensor operable to detect an activity or event within the cargo compartment, and to activate the camera in response to the detected activity or event.

27. A monitoring system according to claim 26 wherein the activity or event is selected from the group consisting of motion, cargo door displacement, and changes in aircraft weight.

28. A monitoring system according to claim 18 wherein the aircraft includes at least one cargo control panel, cargo control unit, or tub containing a cargo control panel or cargo control unit, and wherein the camera is mounted within the cargo control panel, the cargo control unit, or the tub containing a cargo control panel or cargo control unit.

29. An aircraft cargo monitoring system comprising a display configured to selectively display cargo loading or unloading status information and at least one video image of a cargo compartment.

30. An aircraft cargo monitoring system according to claim 29 wherein the display is configured to simultaneously display cargo loading or unloading status information and at least one video image of a cargo compartment.

31. An aircraft cargo monitoring system according to claim 29 wherein the cargo loading or unloading status information comprises at least one current ULD location.

32. An aircraft cargo monitoring system according to claim 29 wherein the display is configured to display aircraft weight and balance information.

33. An aircraft cargo monitoring system comprising a plurality of video cameras positioned within a cargo compartment of an aircraft wherein the combined fields of view of the plurality of cameras include substantially all portions of the cargo compartment.

34. An aircraft cargo monitoring system according to claim 33 wherein at least one of the video cameras is mounted on a sidewall of the cargo compartment.

35. An aircraft cargo monitoring system according to claim 33 wherein at least one of the video cameras is mounted on a ceiling of the cargo compartment.
